(19) United States
(12) Patent Application Publication
(10) Pub. No.: US 2007/0041094 A1
(43) Pub. Date: Feb. 22, 2007

(54) System for reproducing three-dimensional images

(76) Inventor: Juan Dominguez-Montes, Madrid (ES)

Correspondence Address: Charles N J Ruggiero;Ohlandt Greeley Ruggiero & Perle, 10th Floor, One Landmark Square, Stamford, CT, 06901-2682, US

(21) Appl. No.: 10/168,652

(22) PCT Filed: Mar. 19, 2001
(86) PCT No.: PCT/ES01/00109

§ 371 Date: Nov. 8, 2005

(51) Int. Cl. G02B 27/22

(52) U.S. Cl. 359/462

(57) ABSTRACT

The present invention describes a system that is able to reproduce images in three dimensions, that is, stereoscopic, three-dimensional or integral, without the need for glasses or any other device in front of observer's eyes. The number of images necessary is small because the system is able to direct the images to the eyes of each observer. In the case of stereoscopic reproductions, this number is only two and in the case of three-dimensional or integral reproductions it is ten or several tens. Its fundamental characteristics are: it has a great focus field depth of the images which allows these to be directed to the observers' eyes wherever the latter are situated, it uses a single discriminating element of these images for each observer, it is able to reproduce bi-dimensional images both by transparency and by diffusion and it does not use movable elements.

### OBJECT OF THE INVENTION

The present invention describes a system that is capable of reproducing images in three dimensions, that is, stereoscopic, three-dimensional or integral, without the need for glasses, nor any other device in front of the observer's eyes.

### BACKGROUND OF THE INVENTION

Independently of systems developed from 1947, based on the production of images through the coherent interference of light beams called holographic systems, the other systems, including that described in the present invention, are to be classified in one of the following groups: stereoscopic, three-dimensional and integral.

The term “stereoscopic” is used here to designate systems which use only two different images in the reproduction, one for each eye.

The term “three-dimensional” is used to designate systems which use more than two images in the reproduction and which allow observation with parallax within a wide range of horizontal vision, without observers having to be bothered by placing any device in front of their eyes.

The term “integral” is used to designate systems which use a large number of images in the reproduction, thus allowing observation with horizontal and vertical parallax within a wide range of vision.

Most of the systems marketed up to the present time in film projection belong to the “stereoscopic” group.

In these systems two single images are captured from the objectives whose optical centres are separated horizontally between each other.

Many procedure have been used to make each image reach a different eye.

The first solution was proposed by D'Almeida in 1858. His solution consisted of placing a rotating shutter in front of the observer, in such a way that it interrupted the passage of light to one eye or the other alternately. The shutter had to be synchronised with the projector which successively projected the images of the left and right eye. This procedure was abandoned due to the noise, mechanical complication and electrical risk.

An up-dated version of this procedure consists of placing a liquid crystal in front of each eye which prevents light from passing to one eye while allowing it to pass to the other, the images being projected in synchrony with this alternation.

In 1891 Ducos du Hauron suggested, the anaglyphic method of image separation. Images are printed or projected in complementary colours and observed with the filters of the same colours inverted. If the image of the left eye is blue, green and the right is red, the observer's left eye will see the latter through a red filter and vice versa. The most important drawbacks of this procedure are that it is only possible to project images in black and white and that because of the fact that each eye sees a different coloured image, the so-called phenomenon of retina confusion occurs, which causes headaches in many people and nausea in others.

Projection with polarised light eliminates these drawbacks.

The method was patented by Anderson in 1891 and was not made commercially practicable until 45 years later when E. H. Land invented the Polaroid in the U.S.A. The Polaroid is a relatively cheap sheet of polarised plastic material. The process consists of projecting the image of one eye through a filter that is linearly polarised in a perpendicular direction to the filter used for the other eye. The images projected on a metallized screen, which diffuses the light without de-polarising it, are observed by each viewer with a filter, in each eye, polarised in parallel directions to the filters of the projectors.

The biggest drawbacks of this method are that the unwanted image is not completely eliminated; and, if the observer tilts his head, the polarisation planes of the filters turn at the same time and the system loses its effectiveness.

The latter drawback has been resolved in recent times using circularly polarised filters, with left-handed polarisation being used for one eye and right-handed polarisation for the other.

An attempt to free viewers from having to wear glasses with polarised, coloured or shutter filters was started by Ives in the U.S.A., continued by Gabor in Great Britain; much research and many experiments being completed in the Soviet Union.

All these attempts mainly involve a special screen which receives the two images and channels them separately to each of the observer's eyes. Essentially, the screen is made up of a series of opaque plates separated at a distance equal to their width and mounted in front of a diffusing surface. This device is called a trace. The images corresponding to the right and left eyes are projected onto the screen from projectors separated by an appropriate distance and the trace cuts the images into vertical bands. Viewers must sit in a position such that the trace hides one image from one eye and allows the other image to be observed.

This system has several drawbacks among which we may mention its low luminous output and the fact that observers have to keep their heads absolutely still.

Several variants of this system have been proposed, but it seems that none of them are capable of commercial success.

Regardless of which procedure is used to make a different image reach each eye, there is an additional drawback, common to all stereoscopic systems. It arises from the fact that all observers perceive the same parallax, regardless of the observation point they occupy. In the view of a real scene parallax is less for distant observers than for nearby ones. As it is possible to give only a single parallax value for all observers in the stereoscopic system, corresponding to a determinate observation distance, the most distant observers will see objects with disproportionate depth and the nearest observers will see them in the opposite way.

To summarise the stereoscopic systems, it may be said that the two drawbacks common to all of them are:
The need to trouble observers either by placing filters or some other device in front of their eyes or by immobilising their head.
The impossibility of reproducing with a parallax appropriate for each observation distance. This causes a distortion in the third dimension or depth of the reproduced image which is a function of said distance.

The three-dimensional systems arose later. They partly avoid these drawbacks.

Most three-dimensional systems capture images by means of a series of conventional objectives situated in different spatial positions arranged according to a horizontal line or curve.

The reproduction system is different according to the different authors. In the process described in U.S. Pat. No. 1,918,705, Ives uses one or two sections of vertical, convergent cylindrical lenses, depending on whether it is frontal or rear projection and a diffusing surface parallel to said sections.

In this system, the maximum angle of orthoscopic vision is limited by the angle of opening of the convergent cylindrical elements which make up the section. In reproduction rooms which need greater angles of vision than the above, these systems are not satisfactory.

The amount of information managed by these three-dimensional systems depends on the number of images reproduced. As the maximum angle of vision is limited, the maximum number of images depends on the minimum angle occupied by each of them. This number is limited by the optical quality of the cylindrical elements making up the section and, in practice, is insufficient for quality reproductions with distant observers.

In the three-dimensional system described by the author of this invention in U.S. Pat. Nos. 5,004,335; 5,013,147 and 5,357,368, two sections of convergent or divergent cylindrical lenses are used.

In this system the orthoscopic angle of vision is not limited, and can reach 180°, nor is the number of images that can be used. For these reasons the system is appropriate for reproduction rooms with any angle and any distance of observation.

Nonetheless, when the angles and distances of observation required by normal reproduction rooms are used, the number of images needed and therefore the amount of information to be captured and processed are enormously high.

The author of this invention describes, in PCT/ES96/00092, a device for reproducing three-dimensional images without using sections of lenses.

The different images are reproduced sequentially by transparency and appear supported in a liquid crystal that is observed by means of a special illumination.

This device seems to be adequate for reproductions on screen sizes similar to domestic televisions. Its drawback is the large number of images necessary in the reproductions of acceptable angles of vision and therefore the large amount of information that it is necessary to process and represent sequentially in the liquid crystal. The liquid crystals currently on the market are scarcely able to respond to the required frame rate.

In order to overcome the difficulties arising from the large amount of information that has to be processed and sequentially reproduced by transparency, devices have been designed which are analogous to the foregoing, that is, which reproduce the different two-dimensional images by transparency, illuminate it with a special system and focus the luminous beam with the help of a convergent optical system on the eyes of the observer.

There are systems, mentioned below, which do not need mechanical movements for monitoring the observer's head, and others which by incorporating mechanical movements, as well as adding other drawbacks arising from such movements, distance themselves from the device described in this invention, without solving any of the problems described here and will therefore not be mentioned here.

British patent 2,272,579, by David Ezra, describes a device configured analogously to those mentioned above, whose purpose is stereoscopic reproduction, as it uses only two or three different images for a single observer. Therefore, the element that reproduces images by transparency needs only an output that is sufficient for the sequential reproduction of two or three images.

In PCT/US93/08412, Eichenlaub describes a stroboscopic system of illumination which may also be used for stereoscopic reproductions, that is, with only two images and for a single observer.

Other work, such as that mentioned below, deals with a larger number of observers.

European patent 0,576,106 A1, by Eichenlaub, describes a device with a configuration analogous to that of David Ezra. Although his system of illumination and focussing may be used for a large number of observers, due to its lack of field depth, the observers' eyes have to be situated in a flat surface which, although it may be parallel to the floor, means a significant restriction. It also uses a very small number of two-dimensional images, which is possible because the focussing system directs the image corresponding to the left eye to all the left eyes of the observers and analogously in the case of the image corresponding to the right eye.

In European patent 0,656,555 A1, Woodgate et al. describe several reproduction systems all of which are based, like the foregoing, on one or two devices which reproduce images two-dimensionally by transparency, a special system of illumination and a device which focusses the luminous beam onto the observers' eyes. The lack of focus field depth of the illumination system makes it necessary for observers to be situated in a plane that is parallel to the reproduction system, that is, no observer can be situated behind another.

The illumination devices used in the foregoing patents are reasonably simple because they are used for one or very few observers who are specially situated. However, when the illumination device has to cover a wide field of observation with randomly situated observers, it is especially complex and expensive, as we explain below.

The condition to be fulfilled by illumination devices is to make a different image reach each eye of each observer.

In order to fulfill this condition when the observers are not situated in the same plane, the observation angle of each observer must be equal to or greater than the angle of illumination of each lens of the illumination device, assuming moreover that these lenses have no other type of optical aberration.

If one assumes the same focussing plane for all the lenses or objectives of illumination making up the illumination device, the angle of observation is the angle under which the optical centres of the observer's eyes are seen most distant from said focussing plane, from the geometric centre of said plane. The angle of illumination of each illuminating objective is the angle under which the optical centres of two contiguous objectives of illumination are seen from the geometric centre of the above-mentioned focussing plane. The distance between two contiguous optical centres of two lenses or objectives of the illumination device coincides with the width and height these should have, as there cannot be dark areas between two contiguous elements.

It can be demonstrated that the angle of observation must be greater than that of illumination so that the panel of objectives of illumination is able to direct a different image to each eye of any observer.

The angle of observation is determined by the distance to the focussing plane of the most distant observer and by the distance between his eyes.

This value is the maximum the angle of illumination can have. In general, this maximum cannot be chosen as an angle of illumination because monitoring of the observer's head requires the detection of much smaller distances than that between the eyes of any observer.

With this value of the angle of illumination and the distance from the focussing plane to the panel of objectives of illumination, their maximum width is determined. The fact that the angle of illumination must be small and the distance to the focussing plane must be great means that the size of the lenses or the objectives making up the system must be very small.

The surface occupied by the illumination sources of each lens or projecting objective must be sufficient to contain at least a number of horizontal and vertical sources that is equal to the number of possible eyes. Given the necessarily limited size of this surface, the surface occupied by each source and the distance between them has to be extremely small, which means that its position must be controlled very accurately, as it can be affected even by distortions due to temperature changes.

There must be as many sources as the product of lenses and number of eyes, whose situation is controlled by a single electronic processor.

The area of illumination covered by the illumination device depends on the quotient between the diameter of the objective or lens of illumination and its focal distance. If it is intended to cover a large area of illumination, the focal distance of the objectives of illumination must be very small in comparison to their diameter. This complicates the design of these devices.

The foregoing explanation makes it clear that when the illumination systems are designed to cover large areas of illumination and for many randomly situated observers, they need a very complex design and are very expensive to manufacture.

Moreover, in the devices described above all the images are reproduced sequentially by transparency and in their entirety on a single electronic reproduction element, or on two of the same size and characteristics, therefore image reproducers by diffusion, such as cinema or TV projectors, cathode ray tubes, plasma screens, led units etc., cannot be used.

The German patent 4,123,895, by D. Dieter and the European patent 0,114,406, by Meacham and G. B. Kirby, describe another device for reproducing three-dimensional images without using lens sections, which achieve three-dimensional reproduction for a large number of observers and a small number of images.

The different images are projected sequentially upon a conventional diffusing surface and are observed by means of a shutter panel made, preferably, of liquid crystal placed in front of the observer.

The difficulties of this system arise from the inconvenience of placing a panel of liquid crystal in front of and close to each observer.

Reproduction systems which, in addition to horizontal parallax, as used by stereoscopic and three-dimensional systems, also reproduce vertical parallax, are called integral systems.

The invention of integral photography is due to M. G. Lippman in 1908.

The device he conceived consists of a sheet made up of an enormous number of convergent lenses. Behind each of these lenses a different image is captured. Viewing these images through the same lenses reproduces the scene with both horizontal and vertical parallax in pseudoscopic form. A second capturing of this pseudoscopic scene would allow the orthoscopic viewing of the first scene. It is advisable that the lenses and the film in this device make up a single unit so that they remain rigidly joined throughout the process, thus avoiding difficult adjustments.

This system suffers from logical drawbacks arising from the fact that the lenses used are very small and therefore so is the size of the images captured by them. It is also necessary to control the aperture of each lens so as not to invade the field of capture or reproduction of neighbouring lenses. In view of the foregoing, the designs have been complex and practically impossible to market, even in the case of static images.

In U.S. Pat. No. 5,013,147, PCT 90/00014 and patent application PCT/ES96/00092, the author of this work proposed an integral reproduction system based, firstly, on capturing the scene by means of a series of conventional objectives situated in the vertices of a rectangular reticle; and then on the projection from the same number of projecting objectives of these two-dimensional images onto two lens sections made up of convergent or divergent cylindrical optical elements that are perpendicular to each other.

In Spanish patent application No. 9700076, by the same author, an integral reproduction system is described which is based, firstly, on capturing the scene by means of a series of conventional objectives situated in the vertices of a rectangular reticle; and then on the projection from the same number of projecting objectives of these two-dimensional images directly, without any optical support, onto where the different images are focussed. To do this, the input pupils of the projection objectives must have a rectangular shape, the sides of the contiguous rectangles being in contact with each other and without any gaps between them.

In the latter cases, even more than in the first ones, the number of images needed and therefore the amount of information to be processed is enormously high.

Although examination of the drawbacks in the foregoing systems has been limited to those arising in reproduction, capturing is logically much more complex the greater the number of images used. In three-dimensional and integral systems that are appropriate for reproductions with a large number of observers, the capture of such a large number of images is required that an enormously complex and voluminous capturing device must be used, it being impossible in most cases to respond to the needs of filming.

To summarise, it is required that systems of reproduction of images in three-dimensions capture and reproduce a small number of images without troubling observers with any device in front of their eyes.

It has been explained that in systems that have been designed up to now, the difficulties become greater as the number of observers increases.

The device described in this invention resolves these and other drawbacks because it uses a reflexive or refractive optical device, made up of a large number of elements that are “sufficiently small” to provide it with the necessary field depth required by the random situation of observers. It has the additional possibility that for all these elements a single source of illumination can be used, or another type of discriminator for each observation eye, these sources being situated inside a “sufficiently large volume” so as not to need precise positioning. Also, any type of image reproducer can be used, whether by transparency or by diffusion and without using movable elements.

### DESCRIPTION OF THE INVENTION

In order to explain the operation of the system that is the object of this invention, each of the six basic parts which comprise it will be described.

As the first component of the system, a refractive or reflexive element may be used. However, the system will be described with the reflexive element and the refractive element will be considered as a variant.

Thus the first component of the system that is the object of this invention is a retro-reflective screen. This retro-reflective screen is made up of a large number of reflecting elements. A reflector is understood to be the optical part that ensures reflection in the reverse direction to a beam of parallel rays.

The simplest reflector element is made up of two mirrors joined together at an angle of 90° and situated in such a way that the reflecting surfaces are perpendicular to the plane that contains the incident beam. This limitation is overcome if a specular regular tetrahedron is used as a reflecting element, that is, an assembly of three flat mirrors in which every two of them are perpendicular to each other.

The first component of the system that is the object of this invention is a surface with back-reflecting or self-collimating properties, such as that described above, which ensures reflection in the reverse direction and in which the triple mirrors are so small that the direction of the reflected ray, parallel to that of the incident ray, has a small distance so that these directions are to be considered coincident.

Any beam of rays, homocentric at any point, which strikes the retro-reflective surface will, after reflection, become a beam of rays that are practically homocentric at the same point, travelling in the reverse direction.

The second component of the system is an optical element that is able to separate the incident and reflected light beams. The most simple optical part with this property is a semi-transparent mirror forming a non-zero angle with the retro-reflective screen.

Incorporating this second element allows the point from which the beam of divergent rays departs to occupy a physical position different from the point at which the rays converge after back-reflection in the above-described screen.

Thus, corresponding to all divergent beams of rays that are homocentric at any point in space there is another beam of convergent rays at another point distinct from the former. With the two foregoing components, it is possible to make a bi-univocal correspondence between any light-emitting point and another one, distinct and single, where all the rays emitted by the former, after back-reflecting, converge.

In this way, for each eye, considered as a light convergence point, there will be another unique light divergence point situated elsewhere. The totality of observers' eyes will occupy a determinate volume. The points from which the light rays diverge will occupy another volume of the same size situated elsewhere.

In another variant of the same invention a bi-refringent sheet together with a de-polarising sheet may be used as the second component, both being parallel to the retro-reflective screen, since these optical elements can also separate the divergent incident rays from the convergent reflected ones, as will be explained hereinbelow.

In general, at the point where the rays converge an observer's eye will be situated and at the point from where they diverge there will be a light source or simply a point from which a ray of light diverges.

The light captured by a determinate eye is that which is emitted by a single light source after back-reflecting in the screen described in the first place. This eye will see the overhead projection screen uniformly illuminated by that single light source. The same thing will happen for the other eyes of the observers.

As a variant of the foregoing reflexive components, the use of refractive elements may be considered. A retro-reflective element made of refractive material is the screen made up of a large number of convergent lenses, analogous to that used by Lippman for his integral photography, whose rear surface is a diffusing plane. The main drawback of this retro-reflective screen are the unwanted reflections on the convex surface of the convergent lenses. However, if another identical screen is added to this one in such a way that the diffusing plane, in this case translucent, is sandwiched between these two screens like the former, said reflections are avoided.

So that each eye sees a two-dimensional image on the retro-reflective screen it will be necessary to modulate in intensity and colour the light that passes through each element making up the screen described above.

The third component of the system is used as a light intensity and colour modulating element.

The third component of the system is a screen for reproducing two-dimensional images. This screen can generate the images by transparency, as in the case of liquid crystals, by diffusion, as in the case of cinema and video projectors, or by generation of diffuse light, as in the case of cathode ray tubes, plasma screens, led screens or liquid crystal screens illuminated by diffuse light from behind.

In the first case, that is, when the screen reproduces the image by transparency, all light rays are modulated in intensity and colour when they pass through any point of said screen. Therefore this screen, which reproduces by transparency, will be situated parallel to the overhead projection screen mentioned as the first component of the system.

The light from the light sources can be modulated in intensity and colour once or twice, according to whether the screen for reproducing images by transparency is situated between the observer and the separating element or between the latter and the reproducing element.

In the second case, that is, when the screen reproduces the image by projection or generates it directly on its surface, the arrangement of the elements is the same, although it is different from the case of reproduction by transparency.

The diffusing screen is to have the same size as the overhead projector screen and will be situated in front of the elements that emit divergent light rays which, in this case, will have been converted into simple flat mirrors.

The images reproduced, whether by transparency or diffusion, are two-dimensional images. To obtain stereoscopic images, the number of these images must be two; for three-dimensional or integral reproductions, it must be ten or several tens.

If the reproduction is done in a single element by transparency, reproduction of the different images will always be done by multiplexing in time.

If reproduction is done on diffuse screen or by transparency on two different reproducing elements, it will not always be necessary to do it by multiplexing in time. In stereoscopic reproductions, the two images may be projected onto a metallized diffusing screen and each image polarised in a polarisation plane perpendicular to that of the other image, as in the case of ordinary cinema with polarised glasses, or each image may be reproduced on a different reproducing element by transparency, as explained hereinbelow.

The device that is the object of this invention must make a different image reach each eye of each observer without troubling said observer by placing glasses or other devices in front of his eyes. To achieve this, the fourth component of the system is used.

The fourth element that makes up the system is responsible for making a different image reach each eye.

In the most general case in which images are reproduced by multiplexing in time, the fourth element is a simple shutter situated in front of each geometrical place where the generating points of divergent light beams are located, synchronised with the rhythm with which the different images are reproduced.

The optical effect is the same as if each of the discriminating elements were situated in front of each eye of each observer and however the observers are not troubled by any device being placed in front of their eyes.

If the screen which modulates the light intensity and the colour carries out this function by transparency, a variant included in this same invention consists of replacing the shutter and the light source by several sources, one next to another, flashing in synchrony with the generating sequence of the different images.

In the specific case of stereoscopic reproductions, that is, with two single images projected with polarised light in polarisation planes that are perpendicular to each other, the discriminating element may be made up of a pair of polarised filters in the same polarisation planes with which the images are projected.

Except in this case for synchronising the shutter with the image sequence, electronic means are needed which, in addition to multiplexing the images, generate and emit a synchronising signal to the different discriminating elements. These electronic means constitute the fifth element making up the system.

What has been described up to here would allow an appropriate model to be made for stereoscopic projections with only two images, if the observer kept his head still; and for three-dimensional or integral projections if the angle of vision in these covered the entire area in which each observer could situate his eyes.

If, optionally, one wishes to make a stereoscopic or three-dimensional or integral system with a small angle of vision, but which allows observers to move their head freely, it is necessary to incorporate a sixth component in the system.

The sixth component of the system is made up of electronic means that are able to process the information from a detector of the head position of each observer and, according to this information, to control the electronic position of the image-discriminating element to which we referred as the fourth element making up the system.

The system described allows many variants. For example, if one chooses the semi-transparent sheet as the second component element or element that is able to separate convergent light beams from divergent ones, depending on the situation of this sheet, there are different solutions. A separating element may be situated in front of and close to each observer, a single separating element may be situated for all observers between them and the retro-reflective screen and close to the latter, or this separating element may be situated by way of a false ceiling in the projection room, as explained hereinbelow with its corresponding drawings.

A bi-refringent material may also be used as a separating element, thus giving rise to another variant of the same invention described here.

In cases in which the observers are never situated one behind another, a screen may be used as the first component element, made of reflexive material, which reflects only in the horizontal plane and diffuses in the vertical plane. This diffusion may be used as a separating element, in which case it is not necessary to make additional use of an element to separate the convergent beams from the divergent ones. As the first component element a retro-reflective screen may also be used, made of refractive material, such as a lens section which has a translucent rear surface to act as a separating element and a second lens section symmetrical to the first with respect to this translucent surface which prevents anomalous reflections. Using the same model described in this invention, one may make as many variants as different types of retro-reflective screens in the horizontal and vertical planes, as explained hereinbelow with its corresponding drawing.

In short, the device described in this invention is a system for reproducing images in three dimensions that is able to reproduce stereoscopic, three-dimensional or integral images for any number of observers and wherever they are situated without the need for them to use glasses or any other device in front of their eyes, characterised in that it has a retro-reflective screen that is able to ensure the reflection in the same direction and in the reverse path of all rays belonging to any beam of light rays; it also has an element that can separate the light beams according to their direction of travel, a reproducer of two-dimensional images, an element that is able to discriminate among the different two-dimensional images, a first electronic device that can multiplex the different images and emit a synchronising signal identifying the image which is being reproduced at all times and a second electronic device that is able to receive the synchronising signal and control, in accordance with the latter, the discriminating element and, optionally, the latter may also process the electronic signals which indicate the position of the observer's eyes, from a monitor of the head of each observer, and electronically command the image discriminator in accordance with said signals.

### BRIEF DESCRIPTION OF THE DRAWINGS

FIG. 1 shows a reflector element for light rays contained in a horizontal plane.

FIG. 2 shows a reflector element of light rays in any direction and a retro-reflective screen made up of a large number of these elements.

FIG. 3 shows a separating element made up of a semi-transparent sheet with the retro-reflective screen.

FIG. 4 shows a separating element made up of a bi-refringent material and a de-polarising sheet.

FIG. 5 shows a retro-reflective screen which works by refraction.

FIG. 6 shows the retro-reflective screen of FIG. 5 together with a separating element and another symmetrical optical section.

FIG. 7 shows the screen of FIG. 6 working by refraction.

FIG. 8 shows a retro-reflective screen in the horizontal plane and a diffuser in the vertical plane made up of two specular elements.

FIG. 9 shows a retro-reflective screen in the horizontal plane and a diffuser in the vertical plane made up of three specular elements.

FIG. 10 shows a lens section acting as a retro-reflective screen in the horizontal plane and a diffuser in the vertical plane.

FIG. 11 shows two lens sections working by refraction and acting as a retro-reflective screen in the horizontal plane and a diffusor in the vertical plane.

FIG. 12 show the situation of an image-reproducing element by transparency and a semi-transparent sheet as a separating element.

FIG. 13 shows the situation of an image-reproducing element on a diffusing screen and a semi-transparent sheet as a separating element.

FIG. 14 shows the situation of an image-reproducing element by transparency and a bi-refringent sheet as a separating element together with a de-polarising sheet.

FIG. 15 shows the situation of an image-reproducing element by transparency and a screen working by refraction.

FIG. 16 shows different types of discriminating elements.

FIG. 17 shows the discriminating elements responding to the head movements of observers.

FIG. 18 shows a real arrangement of the model with a separating element for each observer and close to the latter.

FIG. 19 shows a real arrangement of the model with a single separating element next to the retro-reflective screen and reproduction by transparency.

FIG. 20 shows a real arrangement of the model with a single separating element as a false ceiling and reproduction by diffusion.

FIG. 21 shows a real arrangement of the model with a single separating element as a false ceiling.

FIG. 22 shows a real arrangement of the model which uses a screen that works by refraction.

FIG. 23 shows a real arrangement of the model using a bi-refringent sheet as a separating element and a de-polarising element.

FIG. 24 shows a diagrammatic arrangement of the model with two image-reproduction systems by transparency and two rows of light sources.

FIG. 25 shows a diagrammatic arrangement of the model with two image-reproduction systems by transparency and a single row of light sources.

FIG. 26 shows a diagrammatic arrangement of the model analogous to FIG. 24, but working by refraction.

FIG. 27 shows a diagrammatic arrangement of the model the same as FIG. 26 with a single row of light sources.

### DETAILED DESCRIPTION OF THE FIGURES

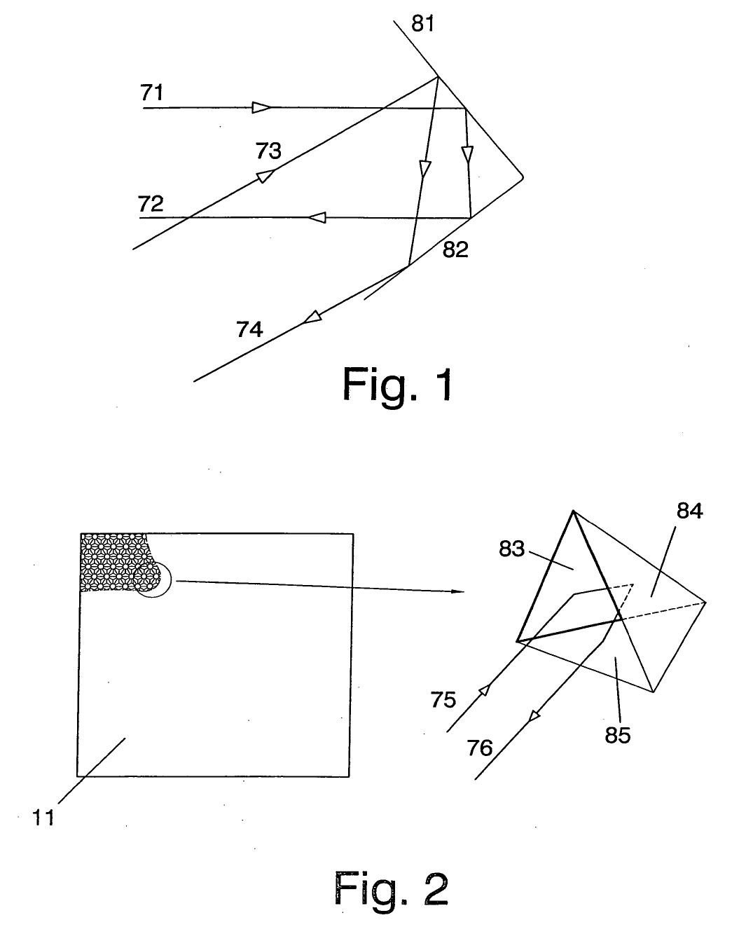

FIG. 1 shows the simplest reflector element. This element is made up of two mirrors 81 and 82 that are perpendicular to each other. In the drawing, the intersecting straight line of the reflecting planes is perpendicular to the plane of the paper. Any incident ray contained in the plane of the paper, for example 71 or 73, will be reflected in a parallel direction and in the opposite path 72 or 74.

FIG. 2 shows a reflector element in the form of a regular tetrahedron in which each of its sides 83, 84, 85 is a flat mirror. Any incident ray, no matter what its direction, for example 75, is returned after three reflections, one in each side of the tetrahedron, in a parallel and opposite direction 76. Also shown in this figure is the screen made up of a large number of small triple mirrors, like those described above, arranged upon a flat rectangular surface 11. This screen constitutes a surface with back reflecting or self-collimating properties and is the first component of the system that is the object of this invention.

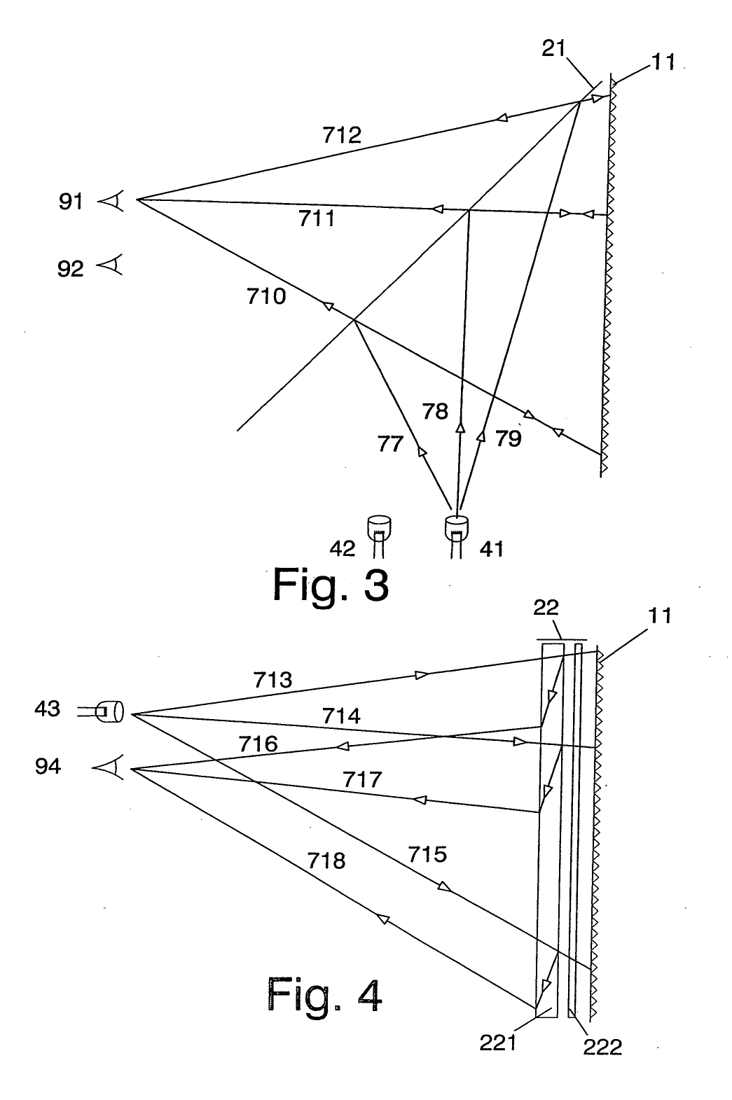

FIG. 3 shows the retro-reflective screen 11, detailed in FIG. 2. The semi-transparent sheet 21 has been placed in front of said screen and said semi-transparent sheet is to be considered as the second component of the system that is the object of this invention. This sheet has the property that it allows approximately half the light energy to pass through it and reflects approximately the other half. The light rays 77, 78, 79 emitted by any light source 41 will strike the retro-reflective screen 11 after being reflected in the semi-transparent sheet 21. This divergent light beam will be reflected by the retro-reflective screen 11, forming a beam of rays 710, 711, 712 which converges at the point 91 after passing through the semi-transparent sheet 21. The optical effect produced by this sheet is to spatially separate the point 41, from which the light rays emerge, from the point 91 where they converge. The rays emerging from any other different light source, for example 42, converge at another point also situated elsewhere, such as at point 92.

FIG. 4 shows the retro-reflective screen 11, detailed in FIG. 2. A bi-refringent sheet 221 and a de-polarising sheet 222 have been placed in front of it. All divergent beams of rays 713, 714, 715 generated by the light source 43 after being reflected undergo a double refraction. A beam of rays reflected after passing through both sheets will follow the direction of the incident beam, but in the opposite path and will converge on the light source 43. The other convergent beam of rays 716, 717, 718 will converge on the point 94, separated vertically from point 43. The optical effect produced by the group of bi-refringent and de-polarising sheets is to spatially separate the point 43, from which the light rays emerge, from the point 94 where they converge. This effect is analogous to that produced by the semi-transparent sheet shown in FIG. 3 and, therefore, this device is considered as a variant of the second component of the system that is the object of this invention.

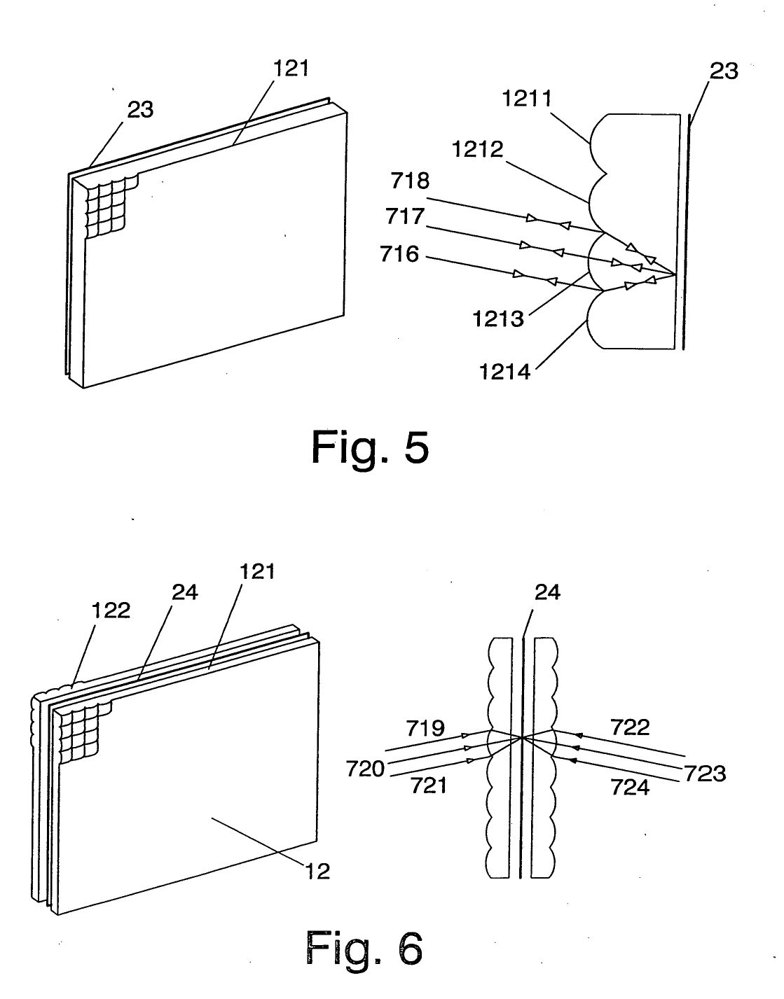

FIG. 5 shows another type of retro-reflective screen which works by refraction. This screen is made up of multiple convergent spherical micro-lenses, such as 1211, 1212, 1213, 1214 in whose focal plane an opaque diffusing surface 23 is situated. All beams of rays 716, 717, 718 striking any micro-lens, for example 1213, is reflected in the same direction but in the reverse path 718, 717 and 716. Likewise for the other convergent beams and any other lens. The group of micro-lenses forms a screen 121-23 such as that shown in said figure, which has back-reflecting properties analogous to that shown in FIG. 2. However, it has the serious drawback of generating unwanted reflections on the convex surface of each micro-lens, which makes it practically useless as a first component of the system.

FIG. 6 shows the retro-reflective screen shown in FIG. 5, in which the opaque diffusing surface 23 has been replaced by a translucent diffusing surface 24 and another identical section of convergent spherical micro-lenses, symmetrical with respect to the diffusing plane, has been added. Any beam of rays 719, 720, 721 striking any micro-lens is focussed on the translucent diffusing surface 24. This focussed beam is dispersed by the surface 24, forming a beam of rays 722, 723, 724 which, after passing through the second section, continues in a direction symmetrical to the incident rays 719, 720, 721. As may be observed, the convergent beam is perfectly separated from the divergent beam and said property may be used to illuminate on one side and observe on the other, thus preventing the unwanted reflections mentioned in the description of FIG. 5. This group of a double section of micro-lenses 121-24-122, which hereinafter we shall call 12, is considered as a variant of the first and second components of the system that is the object of this invention. The optical effect is the same as that obtained by a convergent micro-lens with two convergent cylindrical lenses whose axes are perpendicular to each other. In this way, one or both of the above-mentioned spherical sections may be replaced by a pair of convergent cylindrical sections with the same focal distances and equal to that of the spherical micro-lens, with their convex sides facing each other and one next to another.

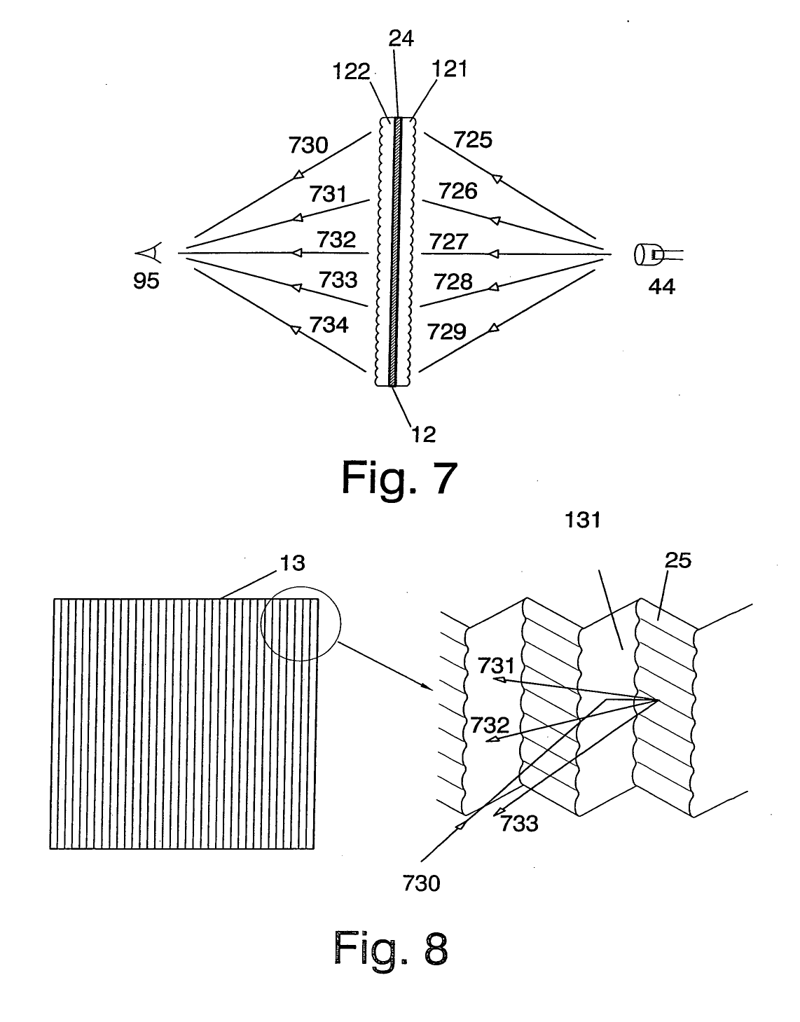

FIG. 7 shows the compound system 12 carrying out the same function as that effected by the first and second component of the system described in this invention. The light rays 725, 726, 727, 728, 729 emitted by any light source 44 affect the optical system 12. This divergent light beam is refracted by this optical system 95, forming a beam of rays 730, 731, 732, 733, 734 that converge at the point 95. The optical effect is to spatially separate the point 44, from which the light rays emerge, from the point 95 where they converge. The rays emerging from any other light sources converge at other points situated elsewhere.

FIG. 8 shows a screen 13 designed by Ives, which is back-reflecting in the horizontal plane and diffusing in the vertical plane. Each reflecting element of which it is made up has two specular surfaces perpendicular to each other 131, 25 in an arrangement analogous to that shown in FIG. 1. One of said specular surfaces is flat 131 and the other 25 is a lens section of specular and divergent horizontal cylinders. This screen 13 may be used as a retro-reflective element and as a separating element, the first and second components of the system that is the object of this invention, for applications in which observers are never situated one behind another and for reproductions with only horizontal parallax. Separation of the divergent incident beam 730 from the convergent reflected beam is due to the fact that the screen diffuses the light vertically 731, 732, 733. Therefore it is easy to situate the points from which the light diverges at a place that is vertically separated from the points at which it converges.

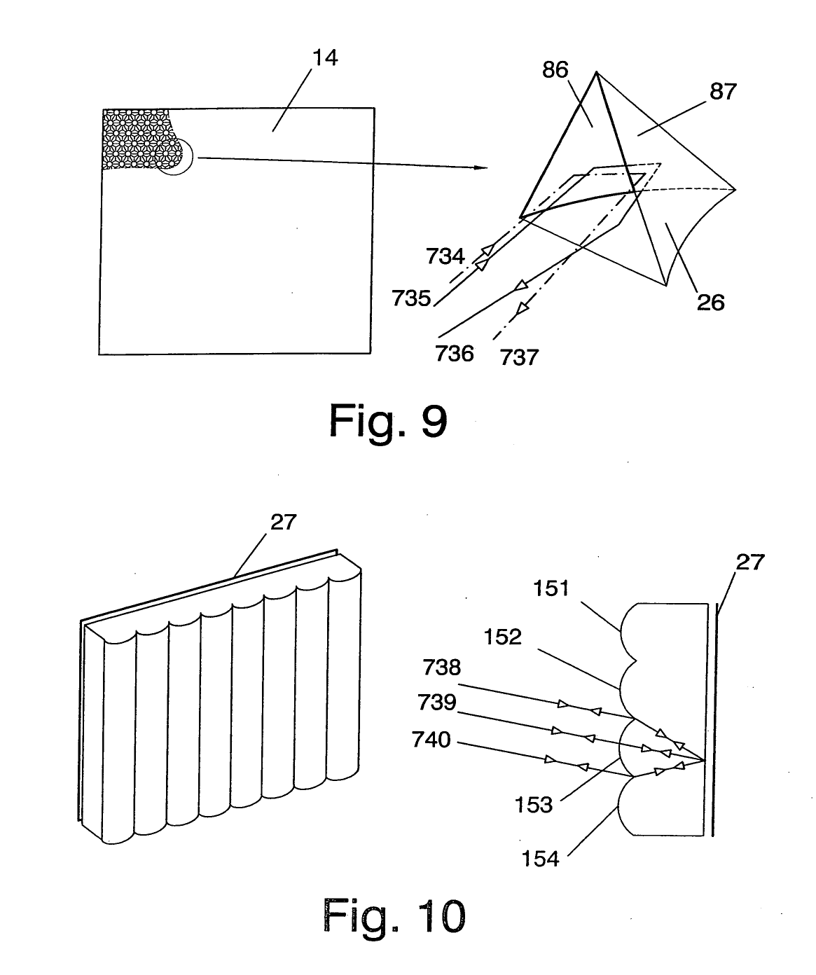

FIG. 9 shows a retro-reflective screen in the horizontal plane and a diffusing screen in the vertical plane. Each reflecting element of which it is made up has three specular surfaces 86, 87, 26 in an arrangement analogous to that shown in FIG. 2. Two of said surfaces 86 and 87 are flat and the third 26 is divergent and cylindrical. This screen 14 can be used as a retro-reflective element and as a separating element, the first and second components of the system that is the object of this invention, for applications in which observers are always situated side by side and never one behind another and for reproductions with only horizontal parallax. Separation of the divergent incident beam 734, 735 from the reflected beam is due to the fact that the screen diffuses the light vertically 736, 737. Therefore it is easy to situate the points from which the light diverges at a place that is vertically separated from the points at which it converges.

FIG. 10 shows a lens section working by refraction made up of vertical cylinders 151, 152, 153, 154 in whose focal plane 27 an opaque diffusing surface is situated. Any incident beam of rays 738, 739, 740 is reflected in the same direction but in the reverse path 740, 739 and 738. The group of vertical cylinders and the diffusing plane form a retro-reflective screen with properties analogous to those described above in FIGS. 8 and 9. However, it has the serious drawback of generating unwanted reflections on the convex surface of each cylinder, which are difficult to prevent by tilting the screen and which make it practically useless as a first component of the system.

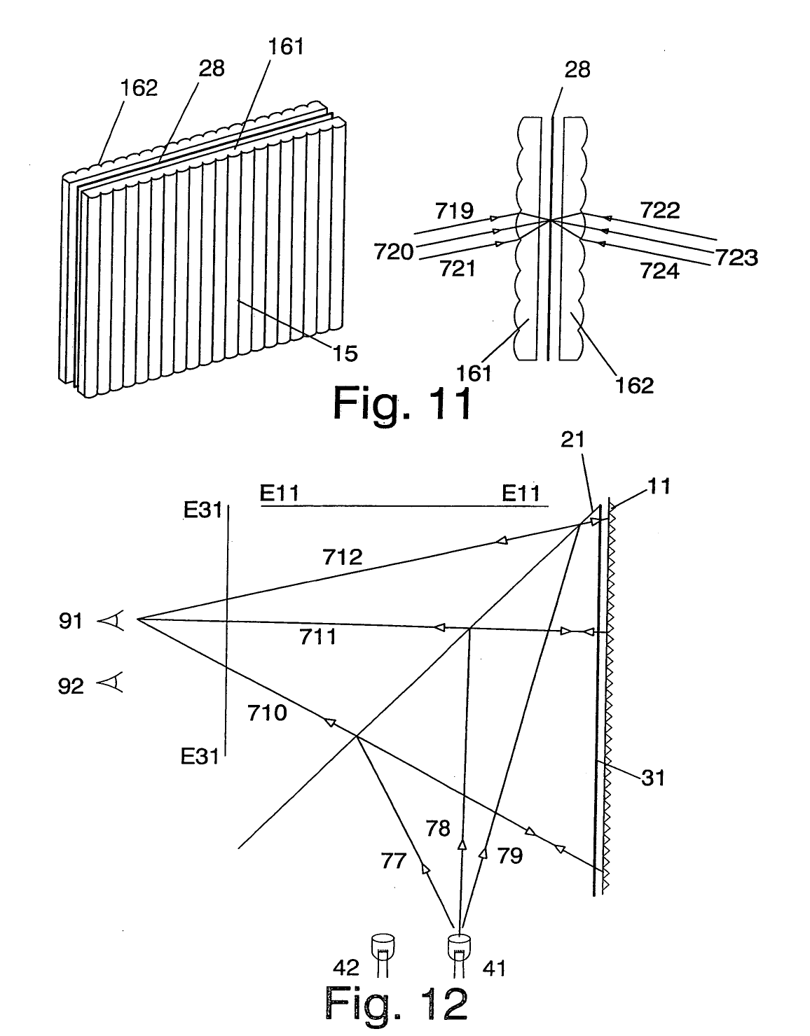

FIG. 11 shows the retro-reflective screen shown in FIG. 10, in which the opaque diffusing surface 27 has been replaced by a translucent diffusing surface 28 and another section of lens section identical to the first and symmetrical with respect to the diffusing plane 28, has been added. Any incident diverging beam of rays 741, 742, 743 is focussed on the translucent diffusing surface 28. This surface disperses the beam, forming a new beam of rays 744, 745, 746 which, after passing through the second section, continues in a direction symmetrical to the incident ray with respect to the translucent surface. The convergent beam is perfectly separated from the divergent beam and said property is used to illuminate on one side and observe on the other, thus avoiding the unwanted reflections mentioned in the description of FIG. 10. This screen 161-28-162, which hereinafter we shall call 15, may be used as a retro-reflective element and as a separating element, the first and second components of the system that is the object of this invention, for applications in which observers are never situated one behind another and for reproductions with only horizontal parallax. Although the right-hand part of this figure is equal to the right-hand part of FIG. 6, they represent two different optical devices. FIG. 6 represents spherical lenses, whereas FIG. 11 represents cylindrical lenses, although logically their profile is the same.

FIG. 12 represents the same optical diagram as FIG. 3, to which has been added the image-reproducing element by transparency 31 parallel to the retro-reflective screen 11 and between the latter and the separating element 21. This reproducing element is considered as the third component of the system that is the object of this invention. All incident beams of light 77, 78, 79 are modulated in intensity and colour by the sheet 31 twice. The first time before being reflected in the screen and the second time after being reflected. The convergent beam with the information from a two-dimensional image, after passing through the sheet 21, converges at the point 91 where an eye may be situated that will see the image reproduced in 31 when the light source 41 is active. Analogously for the source 42 and the eye 92. The eyes 91 and 92 could correspond to those of a single observer. This observer would see a different image with each eye if, when the source 41 is activated, the image corresponding to that eye were reproduced in 31. Moments later 41 will be deactivated and 42 activated at the instant in which the screen 31 reproduces the image corresponding to the other eye. If the image-reproducing element 31 is situated between the observer 91, 92 and the separating element 21, for example at E₃₁, the modulation of light in intensity and colour is carried out only once. In this case a second retro-reflective screen E₁₁ may also be situated, which would duplicate the light energy reaching the observers.

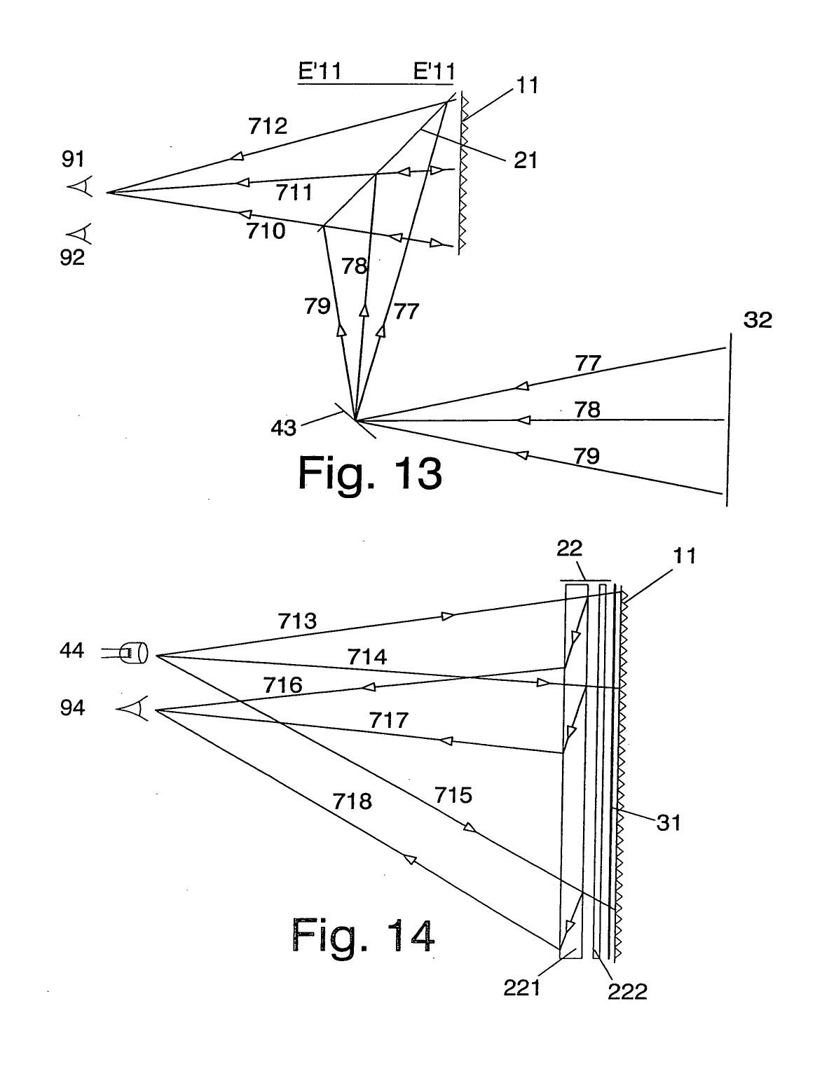

FIG. 13 represents the same optical diagram as FIG. 3, to which has been added the image-reproducing element by diffusion 32 parallel to the retro-reflective screen 11 and of the same size as the latter. The light source 41 of FIG. 12 has been replaced by a flat mirror situated at the same place 43. The image-producing screen by diffusion 32 is considered as a variant of the third component of the system that is the object of this invention. All beams of rays 77, 78, 79 coming from the diffusing screen 32 with the information from the reproduced image will strike the flat mirror 43 where they will be reflected, forming a beam of divergent rays which will be reflected firstly in the semi-transparent sheet 21 and then in the retro-reflective surface 11 to form the beam of convergent rays 710, 711, 712 which will meet at the point 91 where an eye may be situated. It must be pointed out that this FIG. 13 represents only an optical diagram which serves to explain the operation of the system that is the object of this invention with reproductions of images upon a diffusing screen, such as images reproduced with the help of cathode ray tubes, plasma screens, cinema or video projectors, led screens or diffusely back-lit liquid crystal screens. The system will be represented hereinbelow closer to its real-life operation. It should be remarked that reproductions of images on diffusing surfaces require that the element 11 should be a specular screen made up of trios of flat mirrors perpendicular to each other, as we explained in FIG. 2. To double the light flow reaching the observer, another retro-reflective element E₁₁ may be situated.

FIG. 14 represents the same optical diagram as FIG. 4, to which has been added, as a third component of the system, the image-reproducing screen by transparency 31 parallel to the retro-reflective screen 11. All incident beams of rays 713, 714, 715 are modulated in intensity and colour by the sheet 31 twice. The first time before being reflected in the screen 11 and the second time after being reflected. The convergent beam with the information from the two-dimensional image reproduced in 31 converges at the point 94, where an eye may be situated that will see the image when the light source 44 is active.

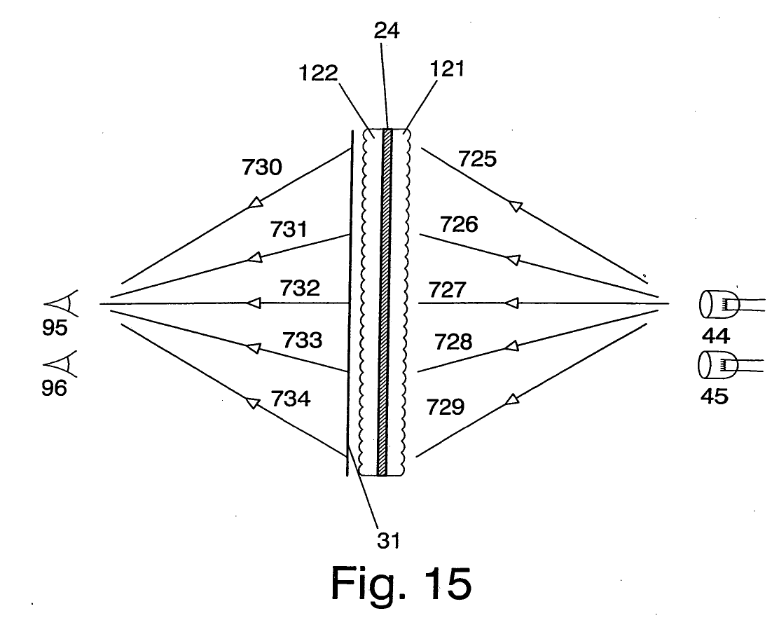

FIG. 15 represents the same optical diagram as FIG. 7, to which has been added the image-reproducing element by transparency 31 parallel to the refracting optical system 13. All divergent incident beams 725, 726, 727, 728, 729 emerging from the source 44, after passing through the system 13, are modulated in intensity and colour by the sheet 31. The convergent beam 730, 731, 732, 733, 734 with the information from the two-dimensional image reproduced at 31, converges at the point 95, where an eye may be situated. If the eyes 95 and 96 correspond to those of an observer, the latter would see a different image with each eye. When the source 44 is activated, the image corresponding to that eye 95 is reproduced at 31. After the source 44 is de-activated, 45 is activated and the image corresponding to eye 96 is reproduced at 31.

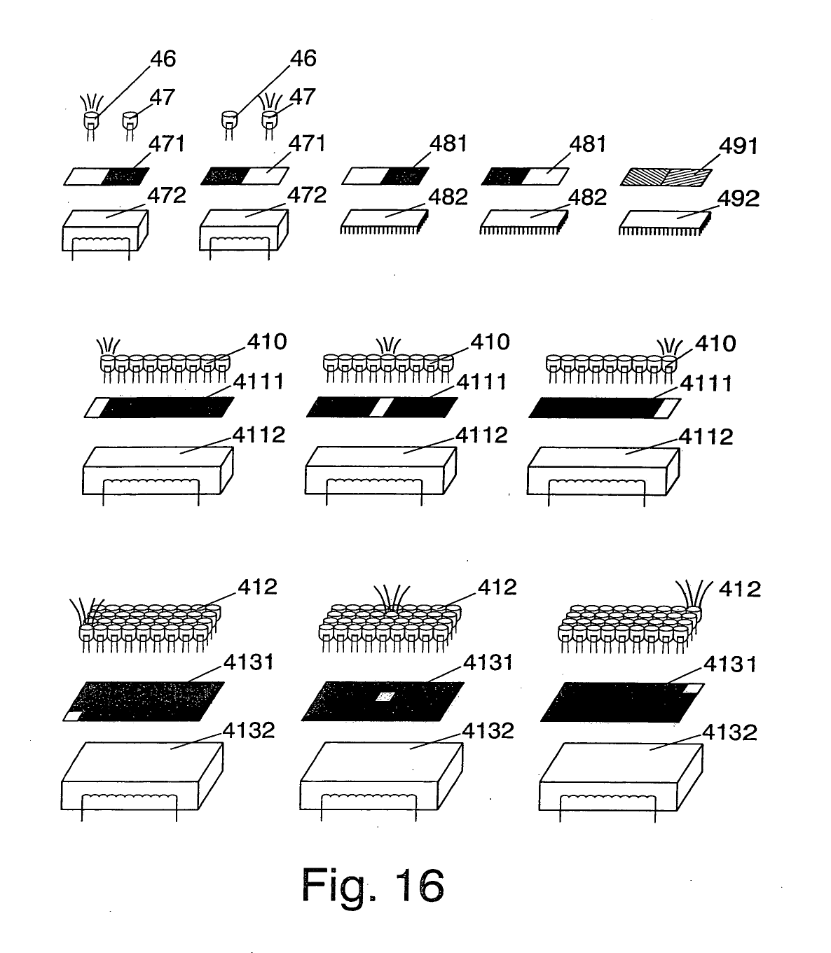

FIG. 16 shows different types of image-discriminating elements. These discriminating elements constitute the fourth component of the system that is the object of this invention. In the optical diagrams shown in FIGS. 12, 13 and 14, each eye 91, 92, 94 may be considered as a convergence point of light beams which originated at another point 41, 42, 43, 44, spatially separated from the first ones. In FIG. 12 the light sources 41 and 42 can be activated and de-activated alternately, and each eye 91, 92 of an observer would see the image reproduced on the reproduction screen 31 according to that alternation. When the source 41 was active, the source 42 would be de-activated and the eye situated at 91 would see the image reproduced at 31. Analogously, when the source 42 was active, the source 41 would be de-activated and only the eye 92 would see the image. In this way, alternating the sources 41 and 42 functions as a discriminating element and therefore these sources 46, 47 have been included as a discriminating element in the upper part of FIG. 16. This alternation may also be achieved with a single light source 472 in front of which a shutter 471 has been placed. This shutter will be able to block the right half, leaving the left half transparent and vice versa.

In the diagram shown in FIG. 13 a shutter may be used such as the foregoing 481, acting as a discriminating element by being situated in front of the mirror 482 which replaced 43 and achieving the same effect. However, as in FIG. 13 the reproduction is made upon a diffusing surface, the possibility exists of reproducing upon said surface a pair of stereoscopic images projected with polarised light, each one in a polarisation plane perpendicular to that of the other. In this case, the discriminating element could be two filters 491 polarised in the same perpendicular planes as above, and a flat mirror 492 to replace 43.

In the case of three-dimensional reproductions in which one needs to reproduce ten or several tens of two-dimensional images, again, as many light sources 410 as images for each observer or an electronic shutter 4111 could be used as a discriminating element and a single light source 4112 in which the transparent window moves from left to right or from right to left in synchrony with the projection of the different images. The width of the light source, or of the transparent window in the case of shuttering, may be different sizes according to the observation distance of each observer; in this way, parallax can be accommodated to the observation distance.

Finally, in the case of integral reproductions, the discriminating element could be a series of light sources 412 whose lighting up cadence would be from left to right and from up to down or an electronic shutter 4131 in front of a single source 4132 whose transparent observation window is a square which moves from left to right and from up to down. In both cases the lighting up of the source or the movement of the transparent window will be carried out in synchrony with the reproduced image. The size of the source and of the transparent window may be made different for each observer according to his observation distance, and parallax can be accommodated to that distance.

Although the luminous area of the sources has been represented in all the figures with a circular shape, in reality it may have any other shape, the most logical one being rectangular.

In order to synchronise the lighting up of the sources or the movement of the transparent window of the shutter, it will be necessary to use electronic means, which constitute the fifth component of the system. This fifth component will carry out the following functions: generate the images for the reproduction screen, emit a synchronising signal for the lighting up of the source or the opening of the shutter's transparent window and, finally, command the opening of said window. The transmission of the synchronising signal may be done electro-magnetically, by radio or light waves, electrically, through a connection cable or electro-acoustically.

The discriminators described above are effective in stereoscopic reproductions with only two reproduced images, if the observer keeps his head still and in three-dimensional or integral reproductions, if the observer moves within the area of vision covered by the sources or by the shutters.

If it is desired that the observer moves freely, it will be necessary to detect the head movement and make the discriminating element to respond appropriately to this movement. This operation will be compulsory in stereoscopic reproductions and optional in three-dimensional or integral reproductions.

To carry out said operation electronic means are needed, constituting the sixth component of the system which, using the input data provided by a detector of the observer's head position, are able to generate an output signal to control the discriminator.

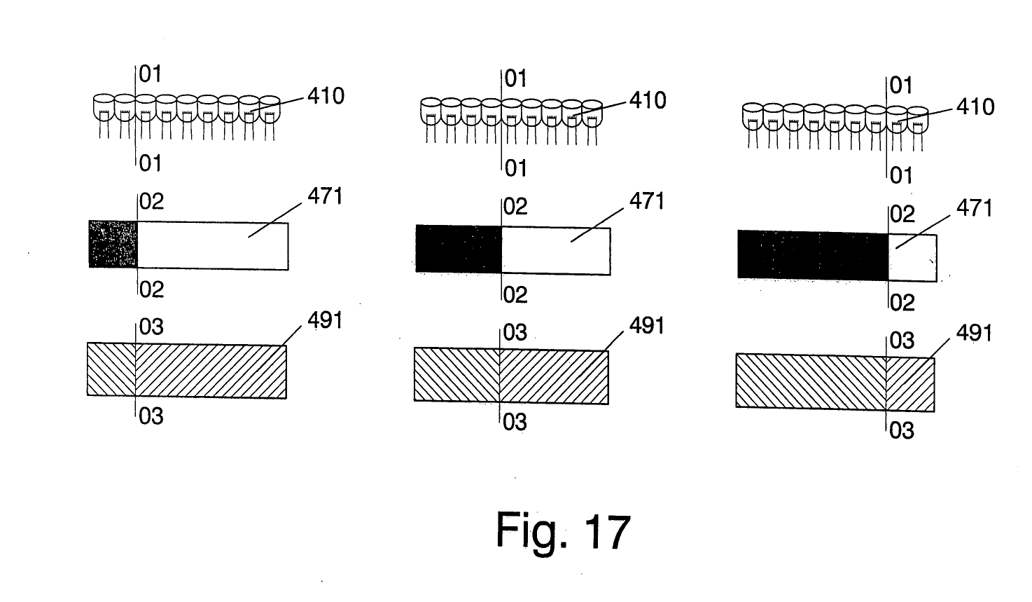

FIG. 17 shows the response of the discriminators to the observer's head movement. In the case of stereoscopic images and if different illumination sources are used as a discriminating element, the latter are to be arranged in a row 410, as indicated in said FIG. 17. The width of the row must be sufficient to cover the whole area in which the observer may move. Depending on the position of the observer's nose, line 01, the lighting up of the sources situated to the left of said line will synchronise with the reproduction cycles of the image of that eye, and analogously with the sources situated to the right of 01 and the right eye. The movement of the observer to left or right is translated into the movement of the line 01 to left or right, as shown in this figure. In the case of stereoscopic images and if a shutter is used, such as 471, in correspondence with the movement to left or right of the observer's nose, the vertical line 02 separating the transparent window from the opaque one or the vertical line 03 separating the polarisation planes that are perpendicular to each other in the shutter 491 will move at the same speed and the same distance. In the case of three-dimensional or integral reproductions, it will be necessary to act upon the discriminating elements only if the area of possible position for each eye is greater than the area covered by the discriminator, in which case the space covered by the shutter 4111 in the three-dimensional reproduction will move horizontally as far as necessary to cover both the observer's eyes when he moves; and in the case of integral reproduction, the area covered by the shutter 4131 will move horizontally and/or vertically over the distance necessary to cover both the observer's eyes.

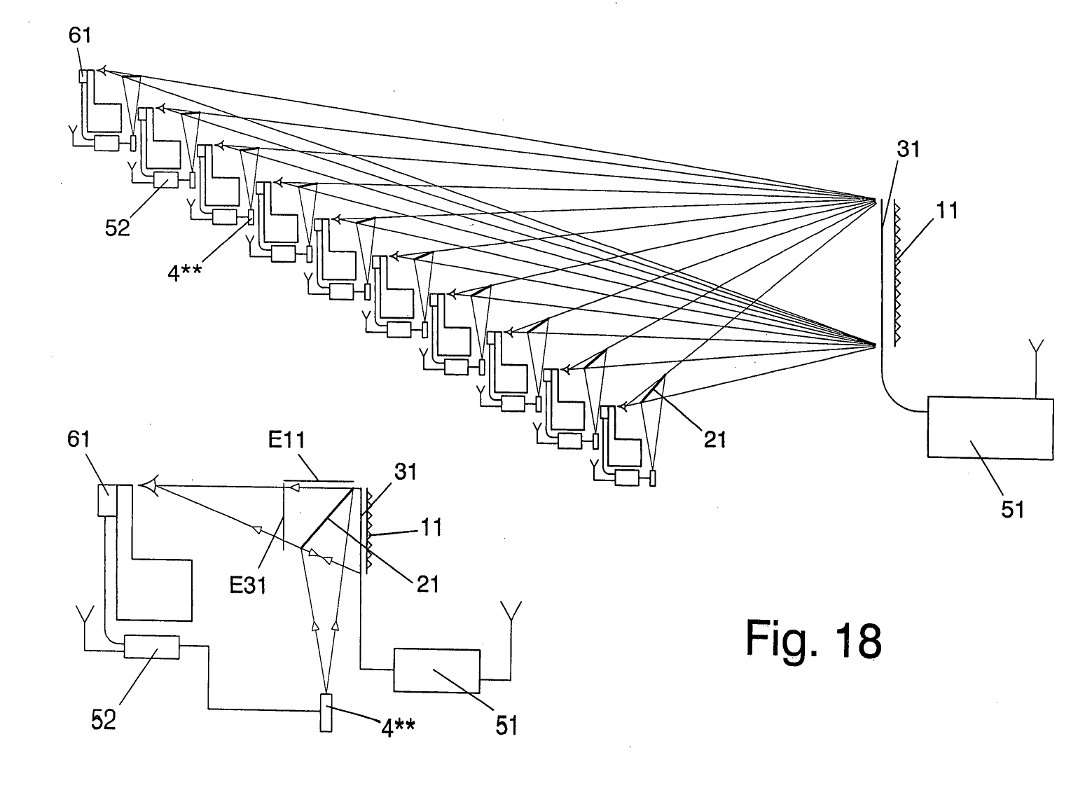

FIGS. 18, 19, 20, 21 and 22, which are commented on below, show some examples of the system that is the object of this invention in reproduction rooms for many observers. The possibilities of placing the different components of the system are very great and a special design must be made according to each room and its shape. The remaining figures show simple guiding diagrams. When several discriminating elements may be used in the figures, they are designated by 4**, where each asterisk represents several different digits.

FIG. 18 shows an arrangement of the different elements of the model for multiple observers. The observers have been situated in tiers so that all of them can see without disturbing each other. A specular overhead projecting screen 11 is used as the first element of the system, such as that shown in FIG. 2. A semi-transparent sheet 21, different for each viewer, is used as a separating element. The reproduction is carried out by transparency on the screen 31 whose signal with the images is received from the electronic means 51. This device 51 also generates a signal with information about which image is being reproduced at all times, which will be received by other electronic means 52. The electronic device 52 receives the synchronising signal from 51 and regulates the discriminating element. Optionally, the electronic device 52 can also receive the signal from a monitor of the observer's head 61 and control the discriminating element with this signal. The discriminator can be any of those shown in FIG. 16, except for elements 481, 491 and the mirrors 482, 492. In the lower part, a single observer is shown, such as the player on a video game. The elements are the same as in the rest of the drawing, the only difference lying in the situation of the separating element 21, which in this case have been situated close to the reproducing screen 31 and distant from the observer. Modulation of the image in intensity and colour is carried out by the reproducing element 31 twice, once when the light beams are directed towards the screen 11 and again after being reflected in the screen. In the drawing in the lower part, where a single observer is represented, a single modulation can be achieved by situating the reproducing screen 31 at position E₃₁. In this case a second retro-reflective screen may also be situated at E₁₁, so that the light flow reaching the observers will be double that of the first case.

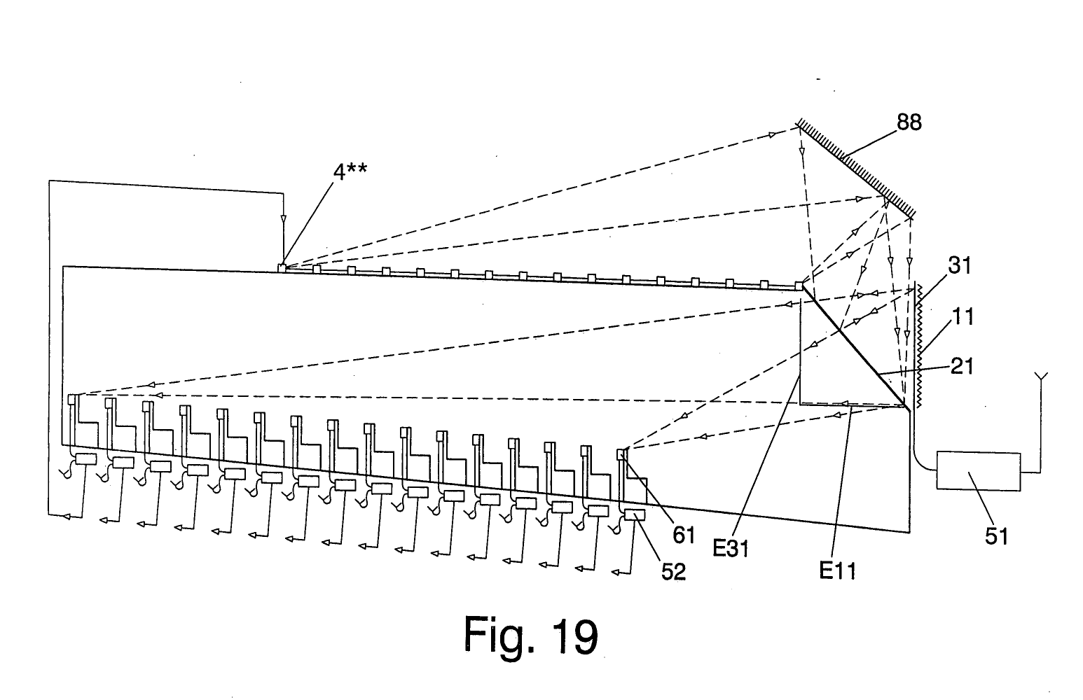

FIG. 19 shows an arrangement of the different elements of the model for multiple observers. The observers are situated in tiers so that they do not obstruct each others' vision. A specular overhead projecting screen 11 is used as the first element of the system, such as that shown in FIG. 2. A single semi-transparent sheet 21 is used as a separating element for all viewers. Reproduction is carried out by transparency on the screen 31 whose image signal is received from the electronic means 51. The electronic device 52 receives the synchronising signal from 51 and regulates the discriminating element. Optionally, the electronic device 52 can also receive the signal from a monitor of the observer's head 61 and control the discriminating element in accordance with this signal. The discriminator can be any of those shown in FIG. 16, except for elements 481, 491 and the mirrors 482, 492. The light emerging from this discriminating element undergoes two reflections before reaching the reproducing screen 31. The first occurs in the flat mirror 88 and the second in the separating element, in this case a semi-transparent sheet 21. The object of the mirror 88 is to situate the discriminating elements along and upon the ceiling of the projection room. However, in another arrangement not shown in the drawing, said mirror can be suppressed and the discriminating elements situated symmetrically with the eyes with respect to the sheet 21. Modulation of the image is carried out by the reproducing element 31, situated between the separating element 21 and the back-reflector 11, twice, once when the light beams are directed towards the screen 11 and again after being reflected in the screen. A single modulation can also be achieved if the reproducing screen is situated at E₃₁. In this case a second retro-reflective screen may also be situated at E₁₁, so that the light flow reaching the observers will be double that of the foregoing case.

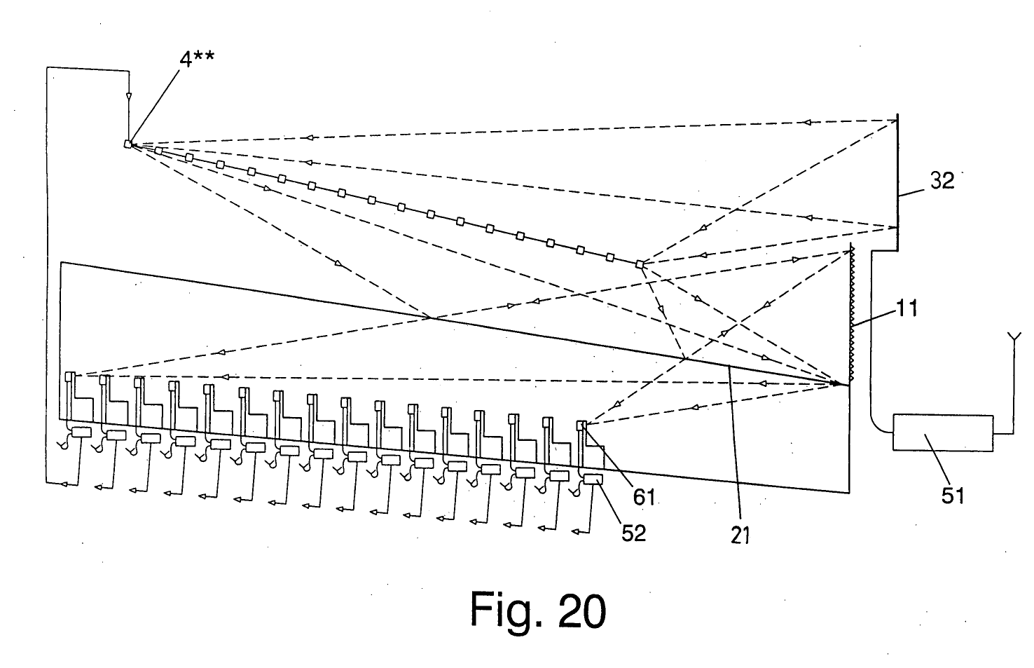

FIG. 20 shows an arrangement of the different elements of the model for multiple observers. The observers are situated in tiers so that they do not obstruct each others' vision. This drawing shows the profile of a reproduction room and each observer represents a row of observers. A specular retro-reflective screen 11 is used as the first element of the system, such as that shown in FIG. 2. A single semi-transparent sheet 21 is used as a separating element, in the form of a false ceiling, for all viewers. The reproduction is carried out by diffusion on the screen 32 whose image signal is received from the electronic means 51 or from a cinema projector. This device 51 also generates a signal with information about which image is being reproduced on the screen 32 at all times, which will be received by the other electronic means 52. The electronic device 52 receives the synchronising signal from 51 and regulates the discriminator. Optionally, the electronic device 52 can also receive the signal from a monitor of the observer's head 61 and control the discriminator with this signal. The discriminator can be 481-482, 491-492 as shown in FIG. 16.

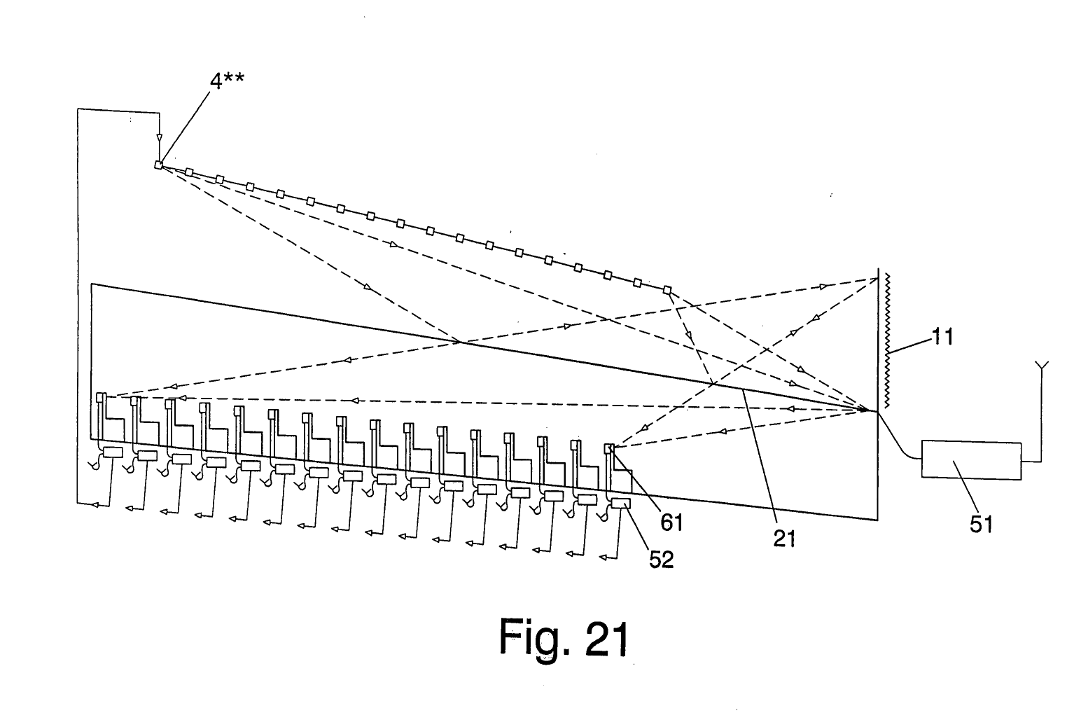

FIG. 21 is another arrangement with the same elements as those in FIG. 18 and with the same features. The difference lies in the situation of the separating element or semi-transparent sheet 21, is now situated as a false ceiling.

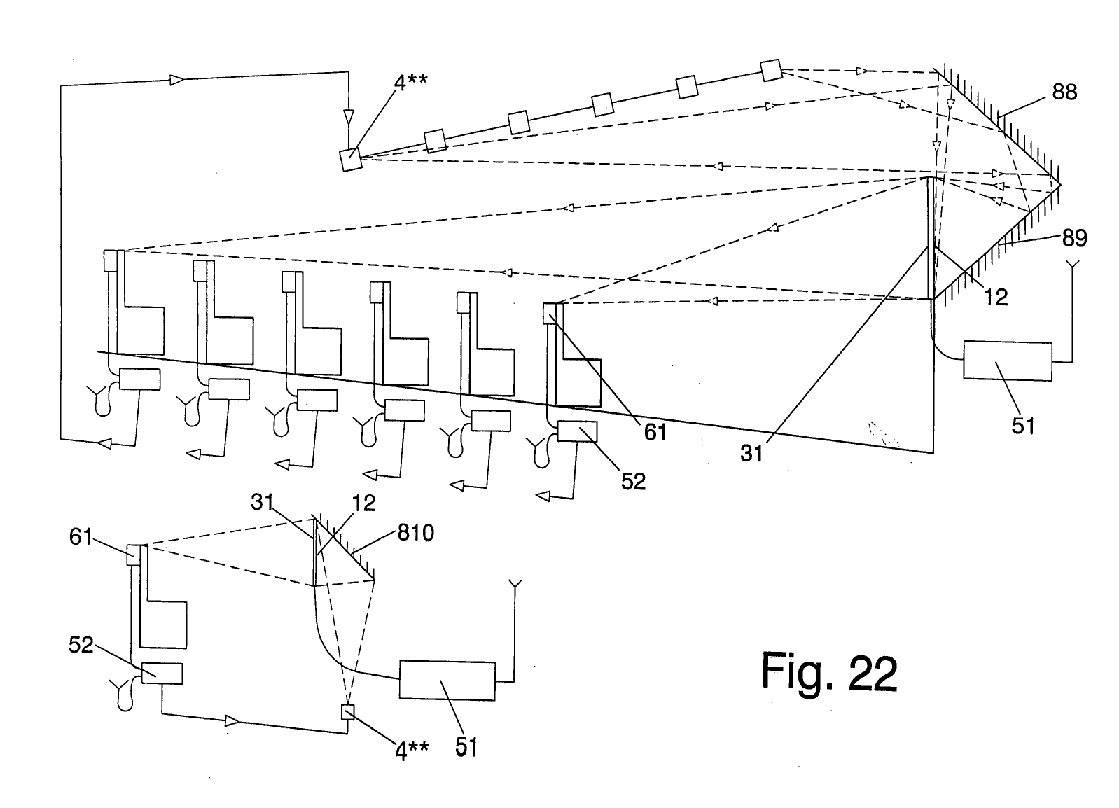

FIG. 22 shows an arrangement of the different elements of the model for multiple observers. The observers are situated in tiers so that they do not obstruct each others' vision. A double section of convergent spherical micro-lenses 12 is used as the first and second elements of the system, joined in the form of a sandwich to a translucent sheet situated in the focal plane of both sections, as described in FIG. 7. Reproduction is carried out by transparency on the screen 31 whose image signal is received from the electronic means 51. The electronic device 52 receives the synchronising signal from 51 and regulates the discriminating element. Optionally, the electronic device 52 can also receive the signal from a monitor of the observer's head 61 and control the discriminating element in accordance with this signal. The discriminator can be any of those shown in FIG. 16, except for elements 481 and 491 and the mirrors 482 and 492. The light emerging from this discriminating element undergoes two reflections before reaching the optical system, after being reflected in the latter it reaches the reproducing screen 31. These two reflections in the mirrors 88 and 89 serve to situate the space occupied by the discriminating elements in the ceiling of the reproduction room. Other arrangements may be chosen, such as for example, situating the discriminating elements symmetrically with the eyes of the observers with respect to the optical system. In the lower part of this drawing a single observer is shown, such as a player on a video game. The elements are the same as in the rest of the drawing, except for the situation of the discriminating element, which in this case emits its light onto the optical system by means of a single flat mirror 810.

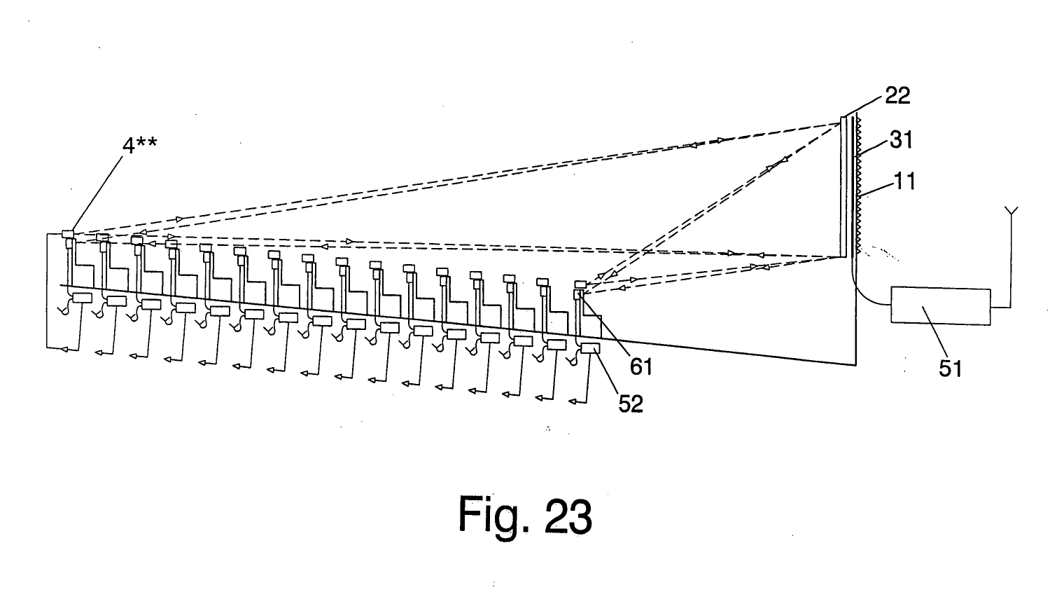

FIG. 23 shows another arrangement of the different elements of the model for multiple observers. The first element of the system is a specular retro-reflective screen 11, such as that shown in FIG. 2. A bi-refringent sheet together with a de-polarising sheet 22 are used as a separating element, both being parallel to the retro-reflective screen 11. Reproduction is carried out by transparency on a reproduction screen 31 whose image signal is received from the electronic means 51. The electronic device 52 receives the synchronising signal from 51 and regulates the discriminating element. Optionally, the electronic device 52 can also receive the signal from a monitor of the observer's head 61 and control the discriminating element in accordance with this signal. The discriminator can be any of those shown in FIG. 16, except for elements 481 and 491 and the mirrors 482 and 492. The discriminating elements are situated above the heads of the observers. The light emerging from these discriminating elements before and after its back-reflection in the screen 11 undergoes a double refraction which allows the divergent incident beam to be separated from the convergent reflected beam. These light beams are modulated by the reproducing screen by transparency 31.

For the sake of simplicity, in the case of reproducing images by transparency, we have preferred throughout the foregoing description to do so upon a single element by multiplexing in time.

In the case of stereoscopic reproductions, that is, reproductions of only two bi-dimensional images, one may, as mentioned above, reproduce each image in a different reproducing element by transparency, that is, by using two reproducing elements.

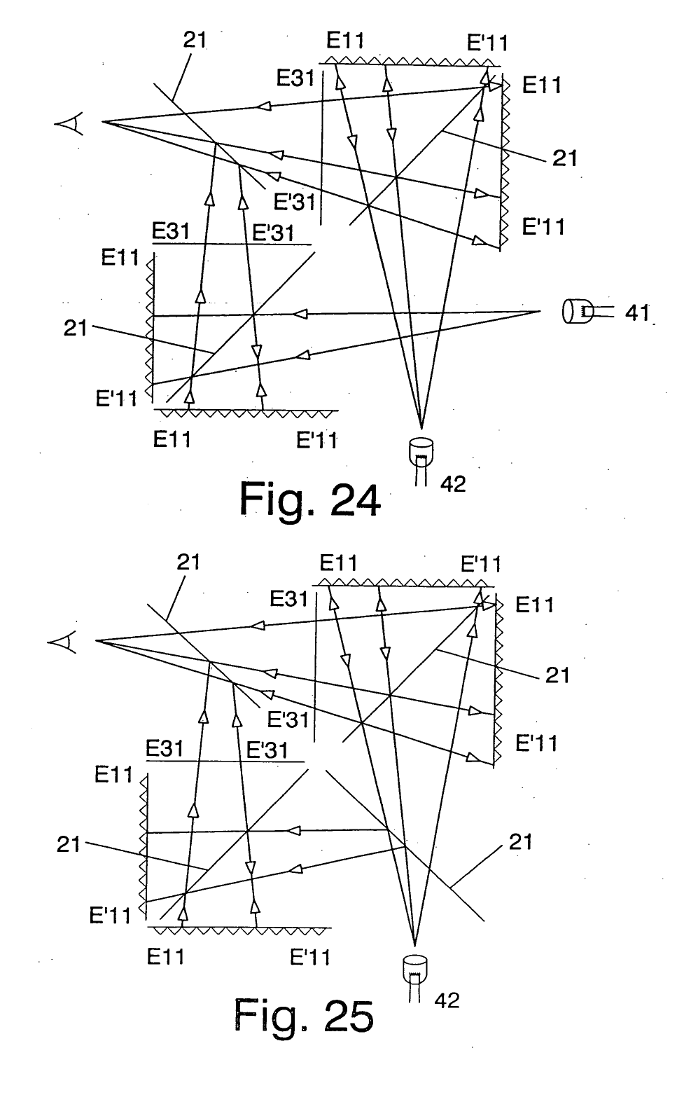

FIG. 24 shows a diagrammatic arrangement of said solution analogous to that of FIG. 12, using the following: four specular elements E₁₁, E′₁₁, two image-reproducers by transparency E₃₁, E′₃₁, three semi-transparent sheets 21 and two rows of light sources 41, 42, one for each eye.

FIG. 25 shows the same diagrammatic arrangement as that shown in FIG. 24, in which a single light source 41 is used together with an additional semi-transparent sheet 21. This sheet and the one which receives light by reflection from it are turned so that the single row of light sources 42 directs its light to two different places, one for each eye.

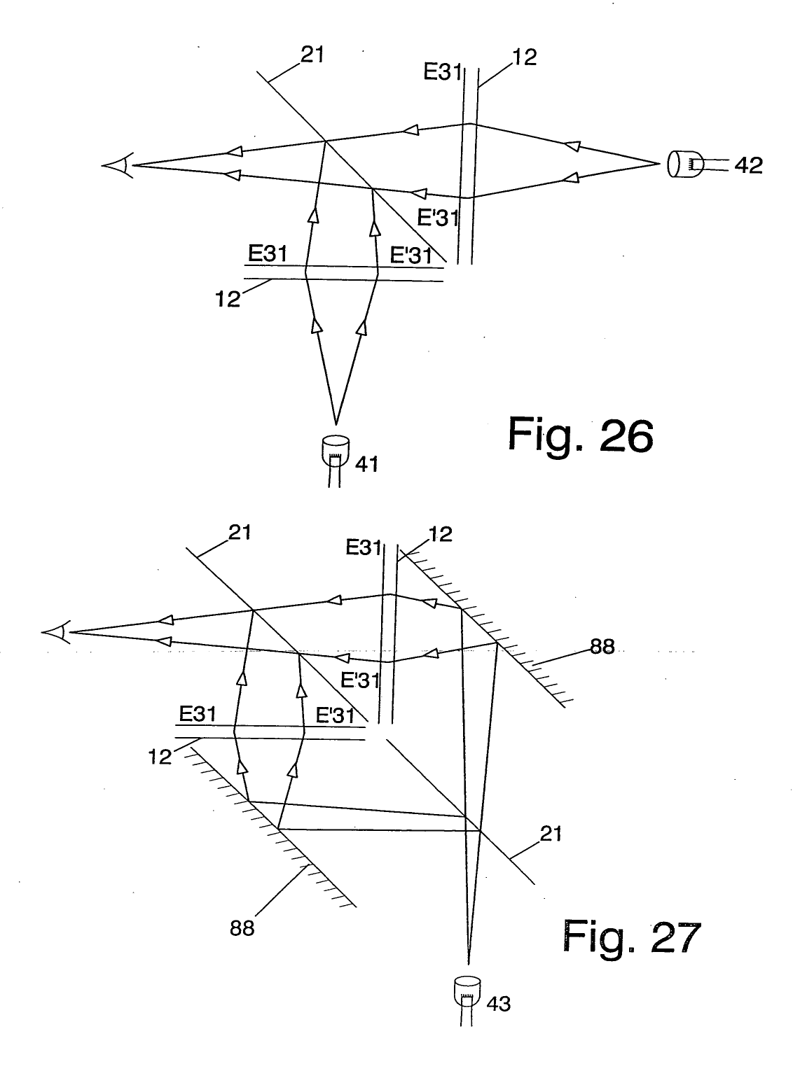

FIG. 26 shows a diagrammatic arrangement analogous to that of FIG. 15, but with two refractive elements 12, two image-reproducers by transparency E₃₁, E′₃₁, a semi-transparent sheet 21 and two rows of light sources 41, 42, one for each eye.

FIG. 27 shows the same diagrammatic arrangement as that shown in FIG. 26, in which a single light source 43 is used together with an additional semi-transparent sheet 21 and two flat mirrors 88. This sheet and the one which receives light by reflection from it are turned so that the single row of light sources 42 directs its light to two different places, one for each eye.

FIGS. 8 and 9 represent two types of retro-reflective screens 13, 14 that are specular in the horizontal plane and diffusing in the vertical plane, which may be used as the first and second components of the model. In this case the reproductions will be solely in horizontal parallax. The separating element is the specular surface of vertical diffusion 25 and 26. The discriminating elements which can be used are those shown in FIG. 16, except for 482, 491, 492, 412, 4131, 4132 and they must be situated as indicated in FIG. 18 or 23, with the proviso that observers can never be one behind another.

FIG. 11 shows a type of screen 15 which works by selective refraction in the horizontal plane and diffusion in the vertical plane, which may be used as the first and second components of the model. Only horizontal parallax can be reproduced. The separating element is the vertical diffusion screen itself 28. The discriminating elements which can be used are those shown in FIG. 16, except for 482, 491, 492, 412, 4131, 4132. FIG. 22 shows a possible physical positioning of the elements with the proviso that observers can never be one behind another.

1-31. (canceled)

32. A system for reproducing images in three dimensions, capable of reproducing stereoscopic, three-dimensional or integral images for at least one observer comprising:
a retro-reflective screen for reflecting in a first direction and an opposite, second direction a beam of light rays;
a bi-dimensional image-reproducer;
a discriminating element for discriminating a plurality of bi-dimensional images from among each other;
a first electronic device for multiplexing said plurality of bi-dimensional images, said first electronic device for emitting a synchronising signal, said synchronising signal for identifying said plurality of bi-dimensional images being reproduced at each moment;
a monitor for sensing a position of an observer's head and providing a head position signal representative of said observer's head; and
a second electronic device for receiving said synchronising signal and said head position signal and for controlling said discriminating element in response to said received signals.

33. A system for reproducing images in three dimensions in accordance with claim 32, wherein said retro-reflective screen comprises a plurality of reflecting elements, each of said plurality of reflecting elements having at least three flat mirrors, at least two of said at least three flat mirrors being disposed perpendicular with respect to one another.

34. A system for reproducing images in three dimensions in accordance with claim 33, wherein said discriminating element is a semi-transparent sheet.

35. A system for reproducing images in three dimensions in accordance with claim 33, wherein said discriminating element is at least one sheet of bi-refringent material and a de-polarising sheet, said at least one sheet of bi-refringent material and said de-polarising sheet both being disposed in parallel relation with respect to each other, and a plurality of retro-reflective screens.

36. A system for reproducing images in three dimensions in accordance with claim 32, wherein said retro-reflective screen and said discriminating element comprises two equal sections, each of said two equal sections being formed on a flat translucent sheet, said flat transparent sheet having a first side and a second side, said flat translucent sheet having a plurality of convergent micro-lenses on said first side, said second side being flat and being connected to said first side, wherein said flat translucent sheet is situated in a focal plane.

37. A system for reproducing images in three dimensions in accordance with claim 36, in which at least one section of convergent micro-lenses comprises:
two lens sections having convex sides and respective axes being perpendicular to each other, said convex sides facing each other and contacting each other, said two lens sections having an focal distance that is equal to said spherical micro-lens.

38. A system for reproducing images in three dimensions, without vertical parallax, in accordance with claim 32, wherein said retro-reflective screen and said discriminating element are a plurality of reflecting elements, said plurality of reflecting elements comprising:
a flat mirror; and
a specular lens section having a plurality of horizontal cylinders, wherein said plurality of reflecting elements and said specular lens section are disposed perpendicular with respect to each other, wherein the least one observer is situated side by side and not situated one behind another.

39. A system for reproducing images in three dimensions, without vertical parallax, in accordance with claim 32, wherein said retro-reflective screen and said discriminating element comprise:
a plurality of reflecting elements having a first surface, a second surface and a third surface, said first and said second surfaces being two flat mirrors, said first and said second surface being disposed perpendicular to each other and said third surface being a cylindrical mirror, wherein the at least one observer is situated side by side and not one behind another.

40. A system for reproducing images in three dimensions, without vertical parallax, in accordance with claim 32, wherein said retro-reflective screen and said discriminating element are two equal lens sections, said retro-reflective screen and said discriminating element comprising:
a plurality of vertical cylindrical lenses having a flat translucent sheet disposed therebetween, said plurality of vertical cylindrical lenses and said translucent sheet being disposed at a focal distance, the at least one observer being situated side by side and not situated one behind another.

41. A system for reproducing images in three dimensions in accordance with claims 34, further comprising a single image-reproducing element for modulating a light source by transparency, wherein said bi-dimensional image reproducer is a liquid crystal.

42. A system for reproducing images in three dimensions in accordance with claim 34, wherein said bi-dimensional image reproducer is situated between said discriminating element and said retro-reflective element.

43. A system for reproducing images in three dimensions in accordance with claim 34, wherein said bi-dimensional image reproducer is situated between the observer and said discriminating element.

44. A system for reproducing images in three dimensions in accordance with claim 34, wherein said images are reproduced by one of the group consisting of a diffuser, a cathode ray tube, a plasma screen, an light emitting diode unit, a back-lit liquid crystal with a flat diffusing screen, a liquid crystal display, a cinema projector, a television projector and any combinations thereof.

45. A system for reproducing images in three dimensions in accordance with claims 43, further comprising a second retro-reflective element disposed perpendicular to said retro-reflective screen.

46. A system for reproducing images in three dimensions in accordance with claim 41, wherein said discriminating element is a light source and an electronic shutter.

47. A system for reproducing images in three dimensions in accordance with claim 41, wherein said discriminating element is a plurality of light sources being disposed adjacent to one another.

48. A system for reproducing images in three dimensions in accordance with claim 44, wherein said discriminating element is a flat mirror and an electronic shutter.

49. A system for reproducing images in three dimensions in accordance with claim 44, wherein said discriminating element is at least two polarised filters, each of said at least two polarised filters having a first and a second polarisation planes, said planes being disposed perpendicular to each other.

50. A system for reproducing images in three dimensions in accordance with claim 35, wherein said discriminating element comprises a plurality of light sources, said plurality of light sources being disposed adjacent and in spaced relation above an observer's head.

51. A system for reproducing images in three dimensions in accordance with claim 35, wherein said discriminating element comprises a light source and an electronic shutter, said discriminating element being disposed in spaced relation above the observer.

52. A system for reproducing images in three dimensions in accordance with claim 32, wherein said bi-dimensional image-reproducer reproduces at least two images.

53. A system for reproducing images in three dimensions in accordance with claim 52, wherein said first electronic device multiplexes at least two images, said first electronic device emitting said synchronising signal having information about said at least two images.

54. A system for reproducing images in three dimensions in accordance with claim 53, wherein said second electronic device processes said head position signal from said monitor, said monitor providing said head position signal in response to a first position of the observer's head, said second electronic device receiving said head position signal, and said second electronic device, in response to said head position signal, controlling said discriminating element, said discriminating element corresponding to the at least one observer.

55. A system for reproducing images in three dimensions in accordance with claim 32, wherein said bi-dimensional image-reproducer reproduces at least ten images.

56. A system for reproducing images in three dimensions in accordance with claim 55, wherein said first electronic device multiplexes a plurality of images, said first electronic device emitting said synchronising signal having information about said plurality of images, said second electronic device controlling said discriminating element in response thereto.

57. A system for reproducing images in three dimensions in accordance claim 56, wherein said bi-dimensional image reproducer reproduces images, said images being reproduced with an angle of vision, said angle of vision being insufficient to cover a first width equal to a width which the observer's eyes may occupy, wherein said second electronic device processes said head position signal from said monitor, said monitor sensing said position of said observer's head, said second electronic device controlling said discriminating element in response to said head position signal.

58. A system for reproducing images in three dimensions in accordance with claim 34, further comprising a plurality of semi-transparent sheets corresponding in number to each of the at least one observer.

59. A system for reproducing images in three dimensions in accordance with claim 34, wherein said semi-transparent sheet is disposed in front of said retro-reflective screen.

60. A system for reproducing images in three dimensions in accordance with claim 34, wherein said single semi-transparent sheet is a false ceiling.

61. A system for reproducing images in three dimensions in accordance with claim 34, for stereoscopic reproduction with only two images, comprising:
at least two image-reproducing elements by transparency;
at least two overhead-projecting elements being disposed perpendicular to each other;
a semi-transparent screen being disposed at an angle of about 45° with respect to said at least two overhead-projecting elements; and
two light sources corresponding to each eye of the observers.

62. A system for reproducing images in three dimensions in accordance with claim 34, for stereoscopic reproductions with at least two images, comprising:
at least two bi-dimensional image reproducers;
at least two overhead-projecting elements being disposed perpendicular to one another, said semi-transparent screen being disposed at an angle of about 45° with respect to said at least two overhead-projecting elements; and
a plurality of light sources disposed in a row.
